(19) United States
(12) Patent Application Publication
(10) Pub. No.: US 2003/0187716 A1
(43) Pub. Date: Oct. 2, 2003

(54) Method and visual user interface for interactive visual analysis of business expenditure

(75) Inventor: Juhnyoung Lee, Yorktown Heights, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY

(21) Appl. No.: 10/108,699

(22) Filed: Mar. 29, 2002

(51) Int. Cl. G06F 17/60

(52) U.S. Cl. 705/10

(57) ABSTRACT

A method (and system) of providing an interactive visual analysis of business expenditure, includes using an interactive graphical view to gain insight into purchase information for assisting in understanding purchase activities and making decisions on purchasing.

### CROSS-REFERENCE TO RELATED APPLICATION

The present application is related to U.S. patent application Ser. No. 10/______,______, concurrently filed on ______, to Juhnyoung Lee, entitled “METHOD AND VISUAL USER INTERFACE FOR EVALUATING AND SELECTING SUPPLIERS FOR ENTERPRISE PROCUREMENT” having IBM Docket No. YOR920010672US1, assigned to the present assignee, and incorporated herein by reference.

### BACKGROUND OF THE INVENTION

1. Field of the Invention

The present invention generally relates to viewing and analysis of business procurement information and, more particularly, to a method and system for analyzing purchase information and a visual user interface for facilitating the analysis of purchase information and providing decision support in procurement.

2. Description of the Related Art

Procurement is an essential part of any business. Reportedly, businesses spend 60% or more of revenue on external purchases of goods and services. For example, a company with its revenue of $1B spends $570M for buying goods and services with non-production (indirect material) purchasing of $348M. It is also reported that the 250 largest publicly held companies in U.S. spent about $1.4 trillion in goods and services in 1999. This amount is a 10% increase over 1998.

Because procurement takes a significant portion of overall business cost, companies are increasingly interested in cutting procurement spending in an effort to increase profitability. A savings of 5 to 15% of a company's total procurement spending by using a “systematic approach to procurement” can translate into millions of dollars in savings for large companies.

Despite its significance, conventional practices of corporate procurement are not always as effective as they need to be and depend heavily on human skills. Indeed, most procurement professionals are left on their own in finding, evaluating, engaging and retaining suppliers. This reality usually stems from the fact that companies do not provide their buyers with information about suppliers that can enlighten decisions about which suppliers to use for which business situations.

Recently, procurement practices using the Internet technology (often referred to as e-procurement) promised to reduce the time, effort and costs associated with requesting, approving, and ultimately, purchasing supplies. However, this technology until now has merely helped reduce paper processing, and does not add much value. Specifically, this technology merely replaces the phone or facsimile machine, and does not save much time, even though it provides minor benefits such as viewing online product information and allowing to place and track orders “24-7” (e.g., 24 hours-a-day, seven-days-per-week). It has been pointed out that this technology automating the purchase process without much decision support capability is only suited for “spot-buying” of indirect materials and other non-critical commodities.

To truly revamp procurement strategies and cover the full spectrum of corporate purchases including the direct/planned group (e.g., key components and key materials), the indirect/planned group (e.g., mission-critical Maintenance Repair Operation (MRO) and capital equipment), the direct/unplanned group (e.g., commodity materials and spot purchases), and the indirect/unplanned group (e.g., office supplies and travel), a systematic approach to purchasing intelligence will be required in the areas of strategic sourcing and supplier relationship management.

Strategic sourcing refers to the process that identifies opportunities, evaluates potential sources, negotiates contracts and continually manages supplier relationships to achieve corporate goals.

Supplier relationship management refers to the practices that are needed to establish strategic relationships with suppliers of products and services that are important to a company's profitability. A systematic approach to supplier relationship management spans all functional areas and requires an enterprise-wide approach to squeeze waste out of the supply chain, and to re-engineer the processes that link buyers and suppliers.

More specifically, the efforts for procurement efficiency such as strategic sourcing and supplier relationship management try to systematically find answers to the following business questions (in several categories) to cut overall procurement expenditure:

Business questions on sourcing: Whom should I buy from? What should I buy from each supplier? How should I buy (e.g., contracts or “spot buying”)? Are there too many suppliers in a particular area (e.g., a consolidation opportunity)? Are there opportunities to consolidate suppliers for greater efficiency or better prices? Are there too few suppliers for mission-critical goods and services? Do I need to diversify suppliers for a particular goods and services? How can I make procurement predictable and repeatable?

Business questions on purchasing: How much to buy? When do I need it? Where do I need it? How much/often are purchases made outside of corporate agreement? How should I eliminate “maverick buying” (i.e., employees purchasing items outside company-wide agreements) by establishing contracts and prices, which all requisitions must reference? How should I negotiate better volume discount and delivery time? How should I consolidate spending to negotiate from a position of strength? To what extent are procurement policies enforced? Are there any duplicate purchases?

Business questions on suppliers: How should I rate and rank suppliers? How much have I spent for each supplier? Who are the top suppliers (in terms of dollar amount, strategic fit, or performance)? How well are suppliers performing with respect to their contract obligations? How should I measure supplier performance over multiple attributes? How much does a particular supplier depend on my company for business?

Business questions on product design: What parts should I reuse for design? What equipment or MRO items do I need? Who should I outsource to? How should I collaborate with my business partners (e.g., suppliers and customers)?

Each of these questions should be asked to obtain the very best procurement and supplier management and strategic sourcing. However, prior to the present invention, there has been no optimum system and method for analyzing purchase information, let alone a visual user interface for facilitating the analysis of purchase information and providing decision support in procurement.

### SUMMARY OF THE INVENTION

In view of the foregoing and other problems, drawbacks, and disadvantages of the conventional methods and structures, an object of the present invention is to provide a method and a visual user interface for providing an accurate overview of a company's total procurement expenditure that summarizes raw purchasing transaction data and other related information.

Another object of the present invention is to find useful answers to these business questions regarding business procurement in an effective manner to save business cost in buying materials, goods and services.

Yet another object of the present invention is to provide a method and a visual interface for allowing multi-dimensional analysis (i.e., view and analysis) of purchase information from different perspectives (e.g., time, suppliers, buyers, product types, and purchase channels) and their combinations.

A further object of the present invention is to provide a method and a visual interface for allowing a user to drill-down and roll-up purchase information along different perspectives and their combinations.

Another object of the present invention is to provide a method and a visual interface for filtering purchase information by dynamically created criteria on different perspectives and their combinations.

A still further object of the present invention is to provide a method and a visual interface for allowing users to view how corporate purchasing policies are enforced.

Another object of the present invention is to provide a method and a visual interface for allowing users to develop business actions that will result in increased savings in a company's procurement.

Yet another object of the present invention is to provide a method and a visual interface for providing timely insight into spending patterns and trends.

A still further object of the present invention is to provide a method and a visual interface for allowing users to drill down to the lowest level of detail necessary to determine root causes of leakage and focus organizational resource on its elimination.

Another object of the present invention is to provide a method and a visual interface for identifying purchases made without the benefit of an existing contract (i.e., “maverick buying” or “leakage”).

A further object of the present invention is to provide a method and a visual interface for allowing users to view “leakage” over a period of time.

Another object of the present invention is to provide a method and visual interface for providing a summarized view of aggregated “leakage” amounts and savings opportunities.

A further object of the present invention is to provide a method and visual interface for allowing users to drill-down the details of leakage amount and savings opportunities from different perspectives.

A still further object of the present invention is to provide a method and visual interface for analyzing suppliers by various attributes.

Another object of the present invention is to provide a method and visual interface for identifying the most efficient and reliable trading partners.

Yet another object of the present invention is to provide a method and visual interface for allowing the users to view information about purchases in windows dynamically generated from the visual interface by using a pointing device such as a mouse, joystick, track ball, touch pad, light pen, etc.

A further object of the present invention is to provide a method and visual interface for allowing the users to dynamically change the range of attribute values for which purchase information is shown in the visual interface by using a pointing device such as a mouse, etc.

In a first aspect of the present invention, a method (and system) of providing an interactive visual analysis of business expenditure, includes using an interactive graphical view to gain insight into purchase information for assisting in making a decision on purchasing.

Preferably, a user of the system, method and visual interface (i.e., a business organization) should be able to record every spending data, especially purchase of goods and services in certain form, and aggregate the spending data in central data storage from various sources of spending data, on-line or off-line. The spending data aggregation often should preferably be processed periodically (e.g., daily, weekly or monthly), to continuously reflect recent activities to the central storage of spending data. Also, the central storage of spending data should take a certain data model to hold spending data and to facilitate the method and visual interface of the present invention.

More specifically, the spending data is held in a data model referred to as a “star schema” that facilitates creating one or more data cubes for multi-dimensional analysis.

The spending data stored in data cubes are rendered into the visual user interface of the present invention that provides a compact data presentation and a graphical interface allowing the users to directly manipulate the components in the presentation to explore and discover useful patterns and trends in the spending data from many different perspectives.

With the unique and unobvious aspects of the present invention, optimization of procurement and supplier management and strategic sourcing results. Further, an optimal system and method for analyzing purchase information is provided, including a visual user interface for facilitating the analysis of purchase information and providing decision support to result in optimum procurement decisions.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a graphical user interface (GUI) 100 for multi-dimensional analysis of enterprise procurement;

FIG. 2 is a block diagram of a system architecture for a multidimensional analysis system 200 of business procurement;

FIG. 3 is a Tree View 300 and a Filter View 310 of the graphical user interface 100 of FIG. 1;

FIG. 4 is a Graphic View 400 of the graphical user interface 100 of FIG. 1;

FIG. 5 is a display 500 of brief information by using a tool-tip operation 510;

FIG. 6 is a display 600 of detail information by using a pop-up window 610;

FIG. 7 is a display 700 of “leakage” information by using an image flag;

FIG. 8 is a display 800 of a trend line in the Graphic View 400 of FIG. 4;

FIG. 9 is a display 900 of summary data of a time value by using a tool-tip operation;

FIG. 10 is a display 1000 showing a drill-down and roll-up of a time dimension in the Graphic View 400 of FIG. 4;

FIG. 11 is a display 1100 illustrating a selection of a y-axis variable;

FIG. 12 is a display 1200 illustrating an elastic zoning by using a scroll bar operation;

FIG. 13 illustrates a block diagram of the environment and configuration of a system 1300 for use with the present invention; and

FIG. 14 illustrates a storage medium 1400 for storing steps of a program of the method for interactive visual analysis of business expenditure.

### DETAILED DESCRIPTION OF PREFERRED EMBODIMENTS OF THE INVENTION

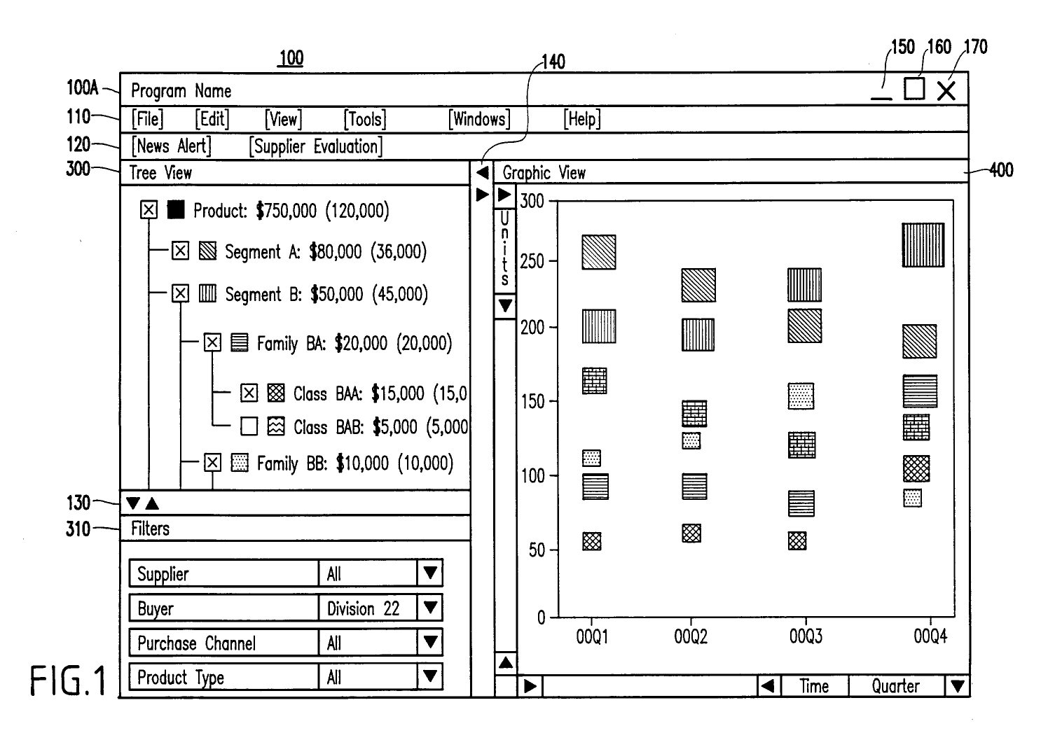

Referring now to the drawings, and more particularly to FIGS. 1-14, there are shown preferred embodiments of the method and structures according to the present invention.

Preferred Embodiment

FIG. 1 illustrates a graphical user interface 100 for multi-dimensional analysis of enterprise procurement of the present invention.

The graphical user interface 100 can be implemented in a desktop software program that can run as a stand-alone application on the user's computer, and/or in a Web application that can run from a Web browser program. Regardless of the execution platform, the system can take the conceptually same graphical user interface 100 for facilitating the analysis of business expenditure from many different perspectives.

The graphical user interface includes several components including a Tree View 300, a Filter View 310, and a Graphic View 400, which will be described in detail later.

The Tree View 300 is a hierarchical presentation of the summarized expenditure data against one or more dimensions selected by the user.

The Filter View 310 is a presentation of every dimension of expenditure data in consideration that were not selected by the user for the Tree View 300. The user can refine the summarized expenditure data shown in the Tree View 300 by using one or more “filters” associated with the expenditure data dimensions provided in the Filter View 310.

The Graphic View 400 provides a visual presentation of the expenditure data shown also on the Tree View 300.

Unlike the Tree View 300, the Graphic View 400 presents the entire expenditure data set in a single screen to help the user explore the information space in an effective manner, and also allows the user to directly manipulate the data point on the view 400 to discover interesting and useful patterns and trends.

The graphical user interface 100 in FIG. 1 provides other features as well as the above-described three view components 300, 310, and 400.

First, the graphical user interface 100 provides the program name bar 100A at the top of the interface. Often, the program name bar 100A displays the data file name that is currently presented in the program, as well as the program name.

Second, the interface provides a menu bar 110 under the program name bar 100A. The menu bar may include one or more menus with each menu being presented as a pull-down menu, which the user can easily access and select by using a computer-pointing device such as a mouse. In FIG. 1, a set of menus that are basic to most computer programs are presented.

For example, the “File” menu may allow the user to open, save, and exit from one or more data files of the program. The “Edit” menu may allow the user to cut, paste, copy, and delete one or more pieces or data in the current data file. The “View” menu may allow the user to change the view of the one or more components 300, 310, and 400 of the data in the current data file by using zooming and other visual effect tools.

The “Tools” menu may allow the user to utilize one or more software applications that work on top of the current program. The current graphical user interface (GUI) provides a tool bar 120 under the menu bar 110. The “Windows” menu may allow the user to select different layouts (e.g., tile or cascade layout) of component windows (i.e., the Tree View 300, the Filter View 310, and the Graphic View 400), in the graphical user interface.

Regarding the “Windows” menu, the graphical user interface provides window separators 130 and 140 among the three component windows (i.e., the Tree View 300, the Filter View 310, and the Graphic View 400). By using the separators 130 and 140, the user can directly re-size the component windows, and shut out and/or maximize one or more component windows with a single click.

The “Help” menu in the menu bar 110 provides various helpful information of the program to the user. The graphical user interface also provides shortcuts (i.e., single click operations) for minimizing 150, maximizing 160, and closing 170 the window of the graphical user interface.

As mentioned above, the current graphical user interface provides a tool bar 120 under the menu bar, 110. FIG. 1 presents several tools in the tool bar 120, including a “News Alert” and a “Supplier Evaluation”. Obviously, other tools could be employed as well, depending upon the designer's requirements and desires.

The “News Alert” feature provides a real-time feed of news related to the corporate expenditure by using the user profile that is configured by the user a priori. The “Supplier Evaluation” feature is another software application that is used to evaluate and select one or more suppliers for a particular purchase need. This feature will be described in detail later.

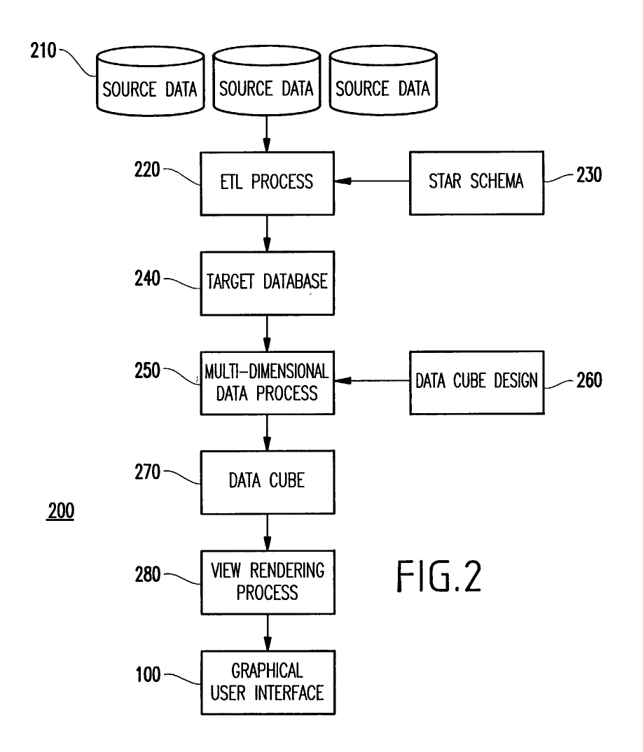

FIG. 2 is a block diagram of system architecture for a multi-dimensional analysis system 200 of business procurement. To assist in accomplishing the objectives of the present invention, a user of the system (i.e., a business organization) preferably records every spending, especially a purchase of goods and services in certain form, and aggregates the spending data in a central data storage from various sources of spending data, on-line or off-line 210.

The source data for business expenditure 210 may include a plurality of different types of data. Indeed, typically each department in a business enterprise may have a database which stores information about purchasing in that particular department.

For example, the source data may include the internal business expenditure information (e.g., private data which is “private” to the corporation and which may originate from in-house sources) such as how much the organization spent annually with a given supplier, the quantities of parts purchased, how often these were delivered on time, how many of these were returned due to defect, etc.

Second, the source data 210 may include related external information such as individual supplier's revenue to calculate the percentage of its business the user organization's expenditure with the supplier represents, and the supplier's current levels of debt and growth to determine how much risk the user organization takes by doing business with the supplier.

Finally, the source data 210 may include standards for classifying suppliers and goods. An example of a de facto standard for supplier classification is a D-U-N-S number from Dun & Bradstreet, Co. Also, an emerging de facto standard for classifying goods and services is UN/SPSC (Standard Product and Service Code). Further, other public data such as stock market reports, etc. could be employed.

The user organization aggregates the source data 210 to create a target database 240. This data aggregation process is often called ETL (Extract, Transform, and Load) process 220. The process may include selecting useful, relevant data from the source databases 210, changing the format of the extracted data, cleaning up the data in case there may be noise in the data, and loading the data into the target database 240.

The ETL process 220 preferably should be executed periodically (e.g., daily, weekly, monthly, etc.), to continuously reflect recent activities to the central storage of spending data (i.e., the target database 240). The target database 240 is often referred to as a “data warehouse”.

The target database 240 holds the data from the data sources 210 in a certain format referred to as “star schema” 230 to facilitate creating one or more data cubes 270 for multi-dimensional analysis.

Traditionally, when there has been a plurality of source data bases storing data regarding purchases in that department, it has been difficult to obtain an overall view of the data. That is, it has been difficult to obtain a consistent view of such a plurality of data pieces and multiple databases because each data has a different structure, a different data schema, a different attribute for different purchases, etc.

The target database 240, using inputs from a star schema 230, provides a consistent view of the data, and may include one set of dimension tables for each data schema which have the same set of attributes. The star schema 230 provides a data warehouse which is used for the overall data structure in the target database 240.

For example, at the center of the star schema 230 is one table called a fact table including measurement data such as purchase price (in dollars) and purchase units. Around this star schema, there can be many tables (e.g., called dimension tables) which provide a context of the measurement data in the fact table.

Thus, the dimension tables provide the context for the fact table. One example may be a time dimension table which stores, for example, when a purchase was made, a supplier table which stores who was the supplier that the purchase was made from, a buyer table which stores who was the employee who purchased the item, etc. It is noted that, for example, the items shown in the filter view 310 in FIG. 1 represent the dimension tables in the star schema 230. Hence, there can be one or more dimension tables, each of which include information shown in the filter view (e.g., supplier, buyer, purchase channel, product type, etc.).

Thus, the star schema helps in the transformation process of the ETL, such that a user can obtain a consistent view of the data across many dimensions.

Further, in the target database 240, a data cube is prepared for the data. In each data cube, each axis represents one dimension. That is, with the input of star schema 230 to the multi-dimension data process 250, the data in the target database is aggregated along data hierarchy of each dimension, and loaded into the data cube structure 270. Basically, the difference between the target database 240 and the data cube is that one may want to perform basic analysis and only extract a portion of the target database and place it in the data cube. Hence, the user may not want to deal with all of the dimensions in the star schema 230, but instead may only want to consider several dimension portions in the data cubes. Thus, a selection process is performed with regard to the multi-dimensional data process 250 based on the data cube design 260, thereby determining which dimension to select and which measurement in the fact table will be used in this data cube.

Thus, to generate one or more data cubes 270, a design of data cubes and filters 260 is created. Again, the design 260 specifies which entries in the target database 240 in the star schema 230 will be used as dimensions in data cubes and how the dimensions are structured in a hierarchical way for filters.

Hence, by using this design of data cubes and filters 260, the multi-dimensional data process 250 creates one or more data cubes 270.

In turn, the view rendering process 280 uses the data cubes 270 to generate the graphical user interface 100 that includes the Tree View 300, the Filter View 310, and the Graphic View 400, optionally based on the user configuration given a priori by the user. In essence, these views in the graphical user interface 100 are different presentations of one or more of the same data cubes 270.

By using the graphical user interface 100, the user can view compact and systematic presentation of business expenditure data, directly manipulate various data points, and filter them with dynamically created data queries in an interactive way to explore, understand, and discover useful and relevant patterns anomalies, and trends in business expenditure from many different perspectives.

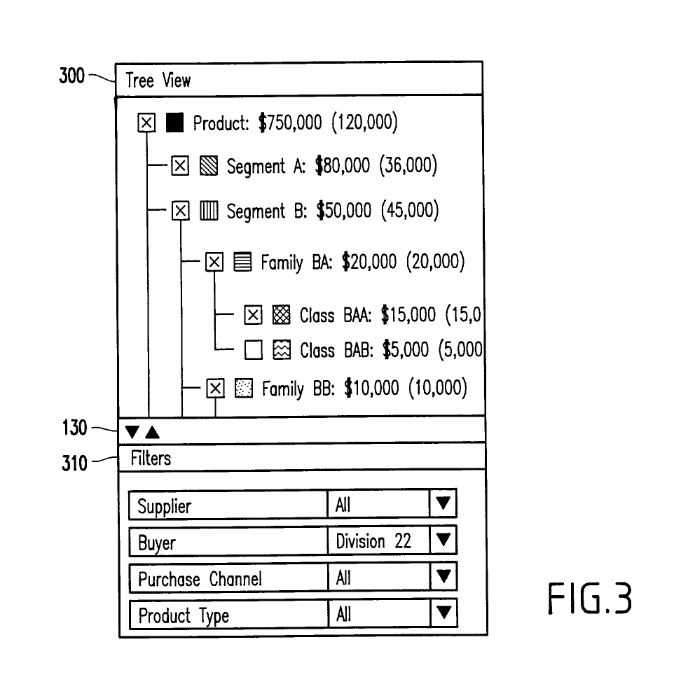

FIG. 3 is the Tree View 300 and the Filter View 310 of the graphical user interface 100. The Tree View 300 is simply a 2-dimensional rendering of a data cube 270, and each entry in the Tree View 300 represents an element cube of a data cube 270, either basic or aggregated.

For example, in FIG. 3, the “Product” has been checked and thus FIG. 3 shows the product hierarchy. “$750,000” represents the aggregated sales (in dollars) of the product (e.g., computers) and “(120,000)” represents the aggregated number of computers sold. Similarly, a tree structure could be shown for supplier data.

Under the “Product” box, there is segment A and Segment B, which may represent, respectively, the number of workstations and the number of laptop computers sold. Hence, each segment generally shows the multiple product family, with each family having multiple classes.

Once a data cube 270 is created and completed with the measurement data for individual element cubes (both basic and aggregated) calculated, the view rendering process 280 generates a plurality of views of the data cube of the graphical user interface of the present invention: the Tree View 300, the Filter View 310, and the Graphic View 400.

FIG. 3 provides a sample Tree View 300 with only one dimension (i.e., product). The product dimension unfolds its data along its hierarchical structure (i.e., from the product segment to the product family to the product class).

As noted above, each entry in the Tree View 300 is associated with a set of measurement data (e.g., basically the units purchased and the unit price). From the basic measurement, the purchase amount in dollar is calculated and is presented along with the purchase units. It is also noted that the measurement data is aggregated for each entry in the Tree View 300, which facilitates the drill-down and roll-up operations in the Tree View 300.

Like most tree views in modem computer software programs as exemplified by the tree view of a hard drive storage Windows® file system in the Windows Explorer® program in most Microsoft Windows® operating systems, the Tree View 300 allows the expansion and collapse operations with a pointing device such as a mouse, etc. Obviously, another input mechanism could be employed as well, as would be known by one of ordinary skill in the art taking the present specification as a whole.

The mouse-based expansion and collapse operations in the Tree View 300 fit well with the drill-down and roll-up operations, because both sets of operations are basically the same operation, except that the data presented by the drill-down and roll-up operations are related across different levels. In contrast, ordinary expansion and collapse operations in tree views do not impose such a restriction.

In the Tree View 300, there are several visual artifacts for individual entries to enable users to effect on the Graphic View 400 which is an information visualization tool that helps the users further understand and discover useful patterns, anomalies and trends.

The user to either include or exclude this data entry in the Graphic View 400 uses the check-box. Initially, the box of every data entry in the Tree View 300 is checked, and every data entry from the Tree View 300 is displayed in the Graphic View 400, so that the user can have an overview of the data entries in the related information space.

Then, the user can de-check check-boxes of one or more data entries in the Tree View to filter out irrelevant entries from the Graphic View 400 and narrow down his/her analysis. It is noted that the check-box of a data entry works individually (i.e., de-checking a box of a data entry does not automatically de-check all the boxes of the child data entries of the initial entry).

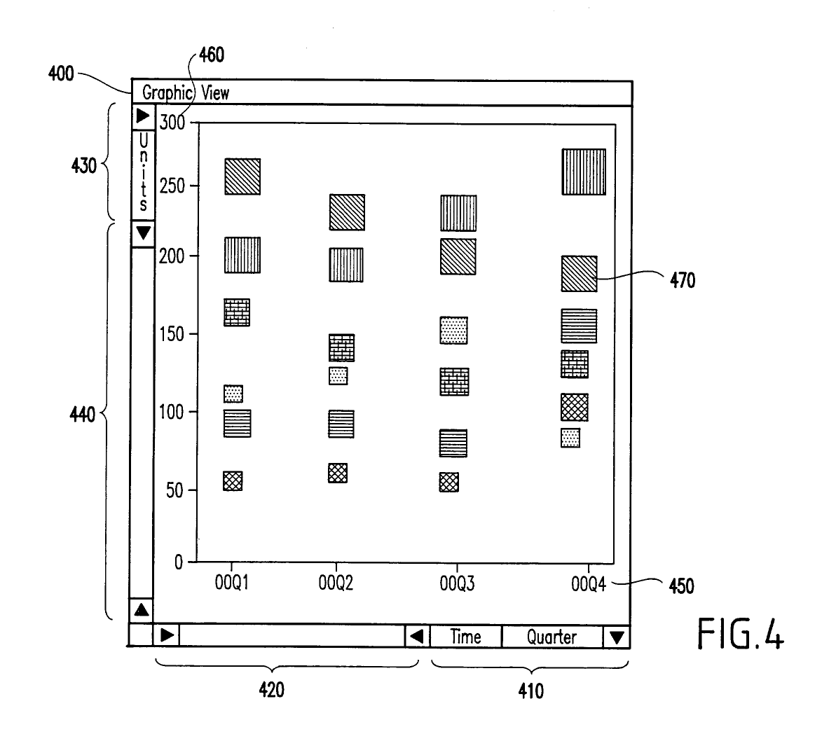

Thus, based on FIG. 3, the user can click on the desired boxes (e.g., product boxes, etc.) and the view is rendered as shown in FIG. 4. FIG. 4 exemplarily represents the number of units sold over time.

That is, the textural-coding box is used to visually differentiate boxes in the Graphic View 400 representing data entries in the Tree View 300. By using this textural-coding in the Graphic View 400, the user can easily identify what box represents which data entry in the Tree View 300 without depending on any textual caption. The effect of the textural-coding can be obtained by using color-coding which is a more popular mechanism in computer graphical user interface design.

In the Filter View 310, all the dimensions available from the prepared in the data cube 270 except the ones already shown in the Tree View 300 are presented. The user of this business expenditure analysis system can select one or more dimensions that are used in the Tree View 300 and the Graphic View 400 from this Filter View 310.

Another important operation provided by the Filter View 310 is dynamic filter creation. Each dimension in the Filter View 310 comes with a pull-down menu with which the user can select one or more attributes in the hierarchical structure of the particular dimension to dynamically create a filter for filtering in data entries that will be shown in the Tree View 300 and the Graphic View 400.

A user of this business procurement analysis system can replace and/or insert into one or more dimensions from the Filter View 310 into the Tree View 300 to change the dimension structure in the Tree View 300, and accordingly that of the Graphic View 400. The views in the Tree View 300 and the Graphic View 400 are automatically coordinated.

As explained above, the dimensions in the Tree View 300 are selected ones for a particular analysis, and they provide a particular perspective to the displayed measurement data.

Also, dimensions in the Tree View 300 are classified as one primary dimension and one or more secondary sub-dimensions. The dimensions displayed in the Filter View 310 are dimensions that are not included in creating a perspective for the Tree View 300 and the Graphic View 400. They are available for dynamically creating one or more filters in the Filter View 310.

Furthermore, the user can modify the dimension structure of the Tree View 300 by using one or more dimensions available in the Filter View 310. A dimension in the Tree View 300, either primary or secondary, can be replaced by a dimension available in the Filter View 310.

Also, one or more dimensions from the Filter View 310 can be inserted into the Tree View 300 as a sub-dimension of a dimension of the Tree View 300, either primary or secondary. In addition, a dimension in the Tree View 300 can be moved to the Filter View 310 without replacement. The user can execute all of these dimension operations between the Tree View 300 and the Filter View 310 by using a drag-and-drop operation with a pointing device such as a computer mouse, etc.

That is, the user need not specify the details of a dimension operation. Instead, the user can select a dimension from one view to another by clicking on the image object or image icon that represents the particular dimension in one view, and drag the image icon to the other view and drop it in the view.

The insertion operation works in a similar way. In this case, however, the user drops the image icon of the new dimension (e.g., say, the supplier dimension), under, not on top of, a dimension in the Tree View 300 (e.g., say, the product dimension.

Then, the new dimension from the Filter View 310 is inserted into the Tree View dimension as a sub-dimension, instead of replacing the Tree View dimension. That is, both the dimensions stay in the Tree View, are appropriately structured and the measurement data for each data entry is adjusted accordingly.

A dimension from the Tree View 300 can be moved to the Filter View 310 by using a similar drag-and-drop pointing device operation. Then, the dimension moved from the Tree View 300 to the Filter View 310 is now available for filtering operations in the Filter View 310, and the drag-and-drop dimension operations. In any case, the Tree View 300 should have at least one dimension in the view. A user cannot move a dimension from the Tree View 300 to the Graphic View 400 when there is only a single dimension existing in the Tree View 300.

Hence, it is noted that good coordination is provided between the tree view 300 and the filters 310. For example, FIG. 3 shows that a buyer in Division 22 has been selected in filter 310 (e.g., the buyer filter dimension), and for all of the other dimensions “All” has been selected. Thus, measurement numbers shown in the tree view (e.g., the number of units and purchase amount in dollars) is based on these filters. That is, the view represents a view of a buyer in Division 22 for all suppliers used, all product types purchased, and all purchase channels used. Thus, the tree view and filter view are well-coordinated.

As is evident, much freedom is provided to the user and tailoring the view and viewing trends, histories, etc. Indeed, the suppliers, etc. can be grouped together so that suppliers could have a hierarchy of classes as well, etc.

FIG. 4 is the Graphic View 400 of the graphical user interface of the procurement analysis system of this present invention.

The Graphic View 400 displays the data entries (with their purchase measurement data, i.e., purchase units and unit prices, either basic or aggregated) on a two-dimensional space with modified scatter plot visualization. The x-axis of the view is preferably always the time dimension 410. The default variable for the y-axis of the view is the number of purchase units 430, regardless of the unit price.

However, unlike the x-axis, the user can modify the variable of the y-axis by using a computer-pointing device such as a computer mouse, etc. The x-axis (i.e., the time dimension), comes with a pull-down menu. The user can dynamically select an appropriate unit of time that is used for the measurement data display in the Graphic View 400. In the given example, quarter 410 was chosen as the time unit that is used to display the measurement data in the view. When the user changes the time unit in the pull-down menu of the time dimension, the view is automatically updated according to the chosen time level.

The small boxes 470 in the Graphic View 400 represent data entries in the Tree View 300 (i.e., purchase measurement data such as purchase units and unit prices).

Each box is associated with two attributes including the size and the texture. The size of individual boxes represents a certain numerical attribute of the corresponding data entry in the Tree View 300. If the size represents the purchase units of the data entry, then the bigger the box is, the higher the box is placed in the Graphic View 400, because the default variable of the y-axis of the view represents the number of purchase units. The (sub-)total purchase amount in dollar is another attribute of data entries in the Tree View 300 that can be associated with the size of the small boxes in the Graphic View 400.

The texture of the small boxes in the Graphic View 400 differentiates the data entries from the Tree View 300, so that the users can identify data entries in the Graphic View 400 by just looking at the texture without looking at any text caption associated with the data entries. Color and other methods such as line thickness, images, etc. may be used for coding the small boxes representing data entries to achieve the same effect. A text caption can be associated with individual data entries in the Graphic View 400 by using a tool-tip operation.

That is, when a user points a particular data entry box in the Graphic View 400 with a pointing device such as a computer mouse for a specific amount of time (e.g., for 5 seconds), a text box automatically appears on the view describing the particular data entry box in text.

Another visual facility provided in the Graphic View 400 is an elastic scroll bar operation 420 and 440 that helps zoning the range of data displayed in the view by using a pointing device such as a computer mouse, etc. The user can select a time range of interest by directly changing the lower and upper limit values of the time range using the arrows of the elastic scroll bar for the x-axis 410. The user can select the range of the y-axis value using the arrows of the elastic scroll bar for the y-axis 460 regardless of the variable currently selected for the y-axis.

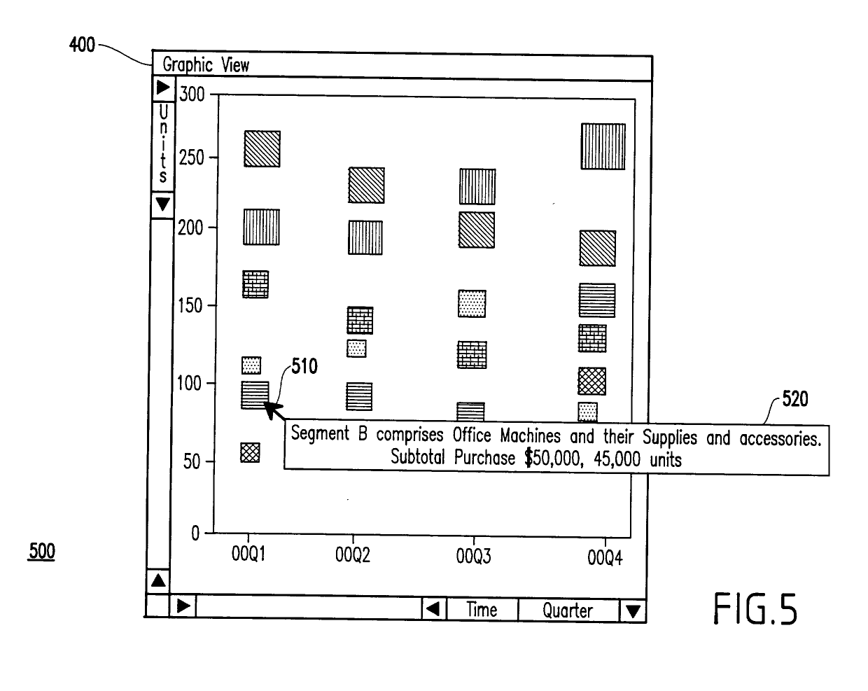

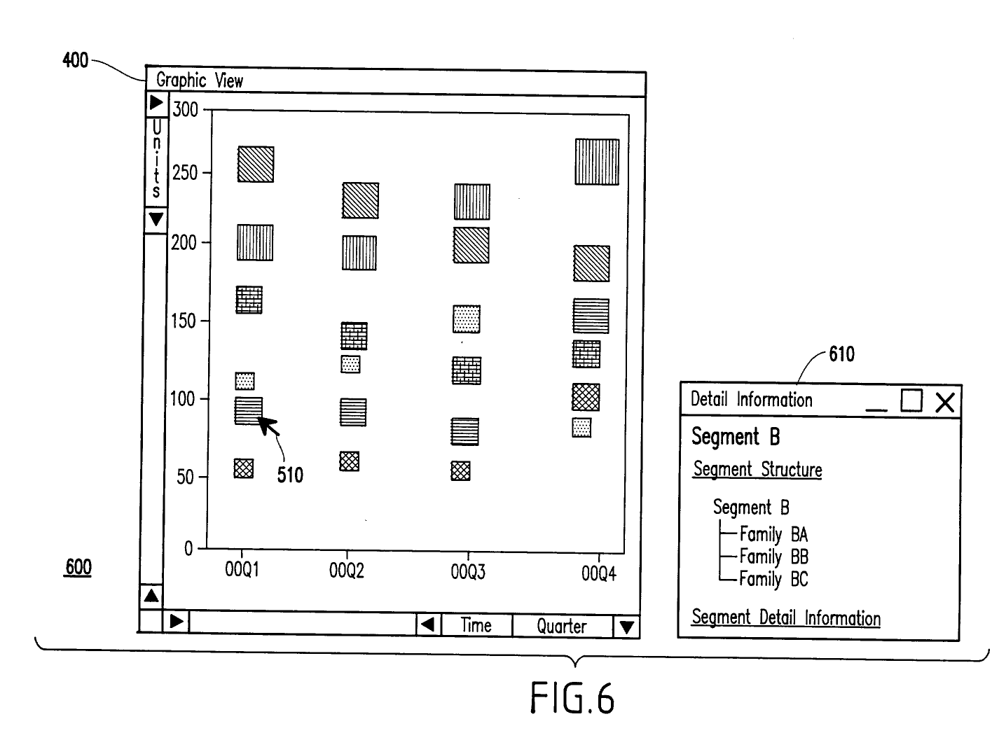

Further, if a user desires more information on a particular purchase, etc., then the user can perform the operations described in relation to FIGS. 5 and 6 below.

FIG. 5 is a display 500 of brief information of a purchase box by using a tool-tip operation. A user can see brief description of data entries in the Graphic View 400 by using a tool-tip operation. When a user points a particular data entry (i.e., a purchase box) 510 in the Graphic View 400 with a pointing device such as a computer mouse for a specific amount of time (e.g., for 5 seconds), a tool-tip box 520 automatically appears on the view that describes the particular data entry (i.e., the purchase box 510).

There is no restriction on the type of the brief information generated by this tool-tip tool. Indeed, the media of the information may be text, visual, image, sound, animation, and so on. In the particular example of FIG. 5, the dynamically generated tool-tip box 520 gives a description about the purchase box 510. The user can see, without looking up any other information system, that the purchase box is one for the product segment B that comprises office machines and their supplies and accessories, and also that the purchase subtotals of the product segment in his/her organization is $50,000 with 45,000 units purchased.

FIG. 6 is a display 600 of detail information by using a pop-up window 610. Certain detail description of data entries (i.e., purchase boxes) in the Graphic View 400 can be provided by using a click operation of a pointing device such as a computer mouse and a pop-up window 610.

When a user points and clicks a particular data entry (i.e., a purchase box 510) in the Graphic View 400 with a pointing device such as a computer mouse, a separate window 610 pops up and certain relevant detail information about the data entry (i.e., the purchase box 510) in the Graphic View 400 is provided in the pop-up window 610.

There is no restriction on the type of the detail information generated in this pop-up window. The media of the information may be text, visual, image, sound, animation, and so on. In the particular example given in FIG. 6, the dynamically generated window 610 provides a description about the purchase box 510. The user can see, without looking up any other information system, detail information about the purchase box (e.g., what it represents, i.e., a product segment, and how the product segment is structured), which cannot be presented in a tool-tip box due to the size and/or other characteristics.

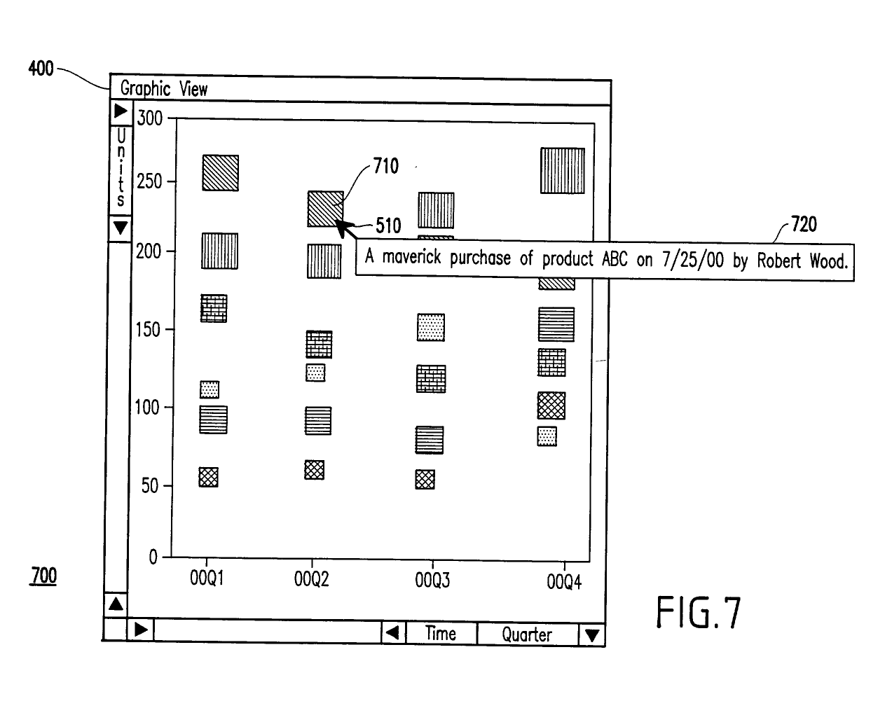

FIG. 7 is a display 700 of “leakage” information by using an image flag.

One of the most significant problems in corporate buying that incurs unnecessary cost is purchases made without the benefit of an existing contract (e.g., often referred to as “maverick buying” or “leakage”). That is, such buying or leakage may occur when a good/service is purchased from a vendor not under contract, on an “approved vendor” list, etc. To prevent such leakage in purchasing and not incur unnecessary cost due to leakage, it is important to track down leakage cases, analyze them from diverse perspectives (e.g., by department, supplier, and/or product type), and understand the trends. From such analyses, the corporation may be able to discover useful clues on why and how leakage happens, and understand how to prevent such leakage (e.g., by fixing defects in existing contracts that may have caused the problem).

The procurement analysis system of this present invention provides a visual user interface to identify maverick buying (i.e., leakage cases) in a visual way and intuitively understand how much leakage occurs in which product category, supplier, buyer, and so on. The leakage cases should be identified by the corporation, and the leakage data should be incorporated into the data cube 270 from the data sources. In the data cube, the leakage is treated as a measurement data along with units and unit prices of purchases, and so is stored in the purchase fact table. Also, along with other measurement data (e.g., units and unit prices), the purchase leakage data is aggregated and propagated into larger element cubes for roll-up and drill-down operations.

When the view rendering process 280 creates the views of the graphical user interface 100 of the procurement analysis system of the present invention, the aggregated purchase leakage data is displayed in the Graphic View 400 as an auxiliary information image flag 710 on top of purchase boxes 510.

As explained above with regard to FIG. 5, the user can view brief information on the leakage by using a pointing device such as a computer mouse, etc. and an automatically generated tool-tip box.

In the particular example given in FIG. 7, the tool-tip box reports a maverick buying of a product ABC by an employee named Robert Wood on Jul. 25, 2000. It is noted that, if there is more than one maverick purchases happened for a purchase box displayed in the Graphic View 400, then the entire maverick buying information is aggregated and summation of the information will be displayed in association with a leakage flag 710 in the view.

Thus, as shown in FIG. 7, a small icon can be provided on the boxes in the graphic view 400 and the user can obtain information on a maverick purchase.

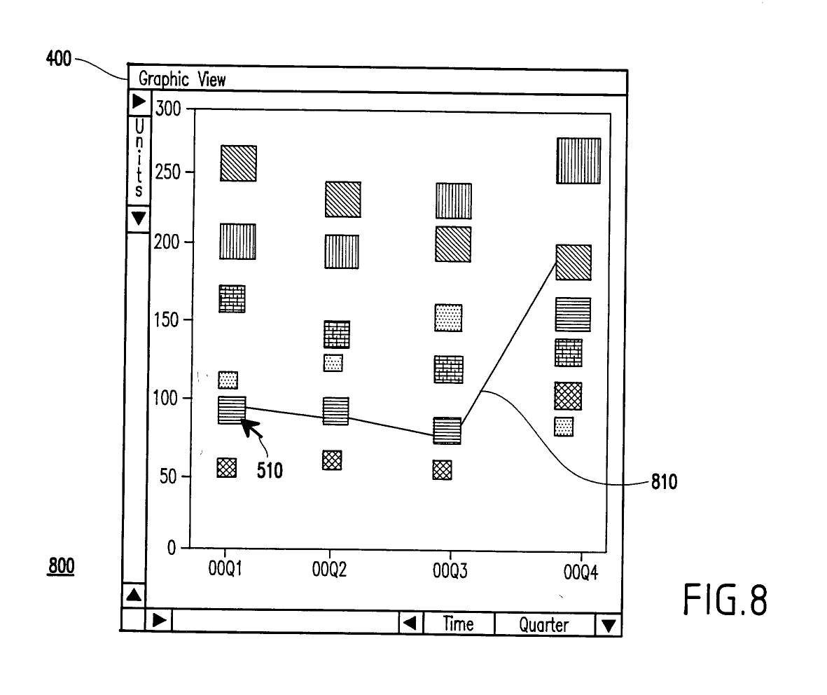

FIG. 8 is a display 800 of a trend line in the Graphic View. In the Graphic View 400, data entries (e.g., purchase cases such as a product segment, a department, or a supplier group) from the Tree View 300 are distinguished by their texture, as explained earlier. Hence, purchase boxes that have the same texture represent the same purchase cases, and the user can visually track the changes of a purchase box by checking the location and size of its box in the view.

However, visually tracking the location and size of a purchase box in the Graphic View 400 is not always easily done, especially when there are many purchase boxes displayed in the view. In such cases, the user can reduce the number of purchase boxes by using check-boxes associated with purchase cases in the Tree View 300 to make it easier or possible to trace a movement of a purchase box over time in the Graphic View 400.

Another method that the user can utilize is to display a trend line that connects all the boxes that belong to the same purchase case (e.g., a product segment, a department, or a supplier group) to help the user to visually trace the purchase boxes in the Graphic View 400. A user can generate a trend line by using a pointing device such as a computer mouse. For example, the user can simply point to a purchase box with a pointing device and double-clicking on the box to generate a line 810 that connects all the boxes that belong to the same purchase case.

Thus, with a quick glance to FIG. 8, the user can tell that a product's sales went down in the second and third quarters, but went up significantly in the fourth quarter.

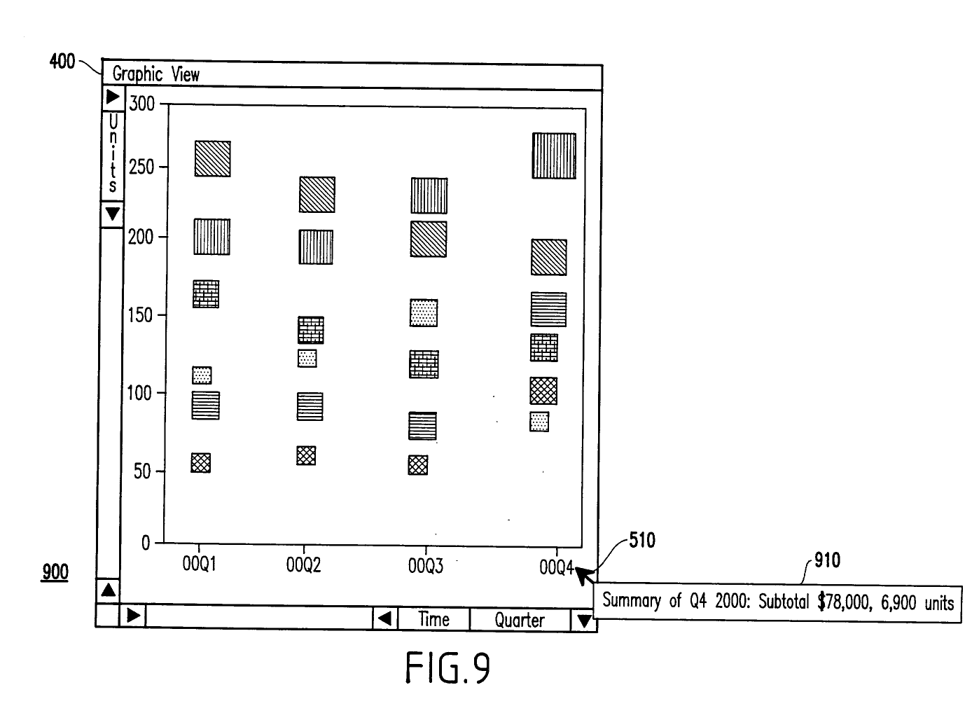

FIG. 9 is a display 900 of summary data of a time value by using a tool-tip operation. A user can see a summary of data entries in the time dimension of the Graphic View 400 by using a tool-tip operation.

When a user points to a particular data entry (i.e., a time value) 510 in the Graphic View 400 with a pointing device such as a computer mouse for a specific amount of time (e.g., for 5 seconds), a tool-tip box 520 automatically appears on the view that describes the particular data entry (i.e., the time value 510). There is no restriction on the type of the brief information generated by this tool-tip tool. The media of the information may be text, visual, image, sound, animation, and so on.

In the particular example given in FIG. 9, the dynamically generated tool-tip box 910 provides a summary of the fourth quarter 510. The user can see, without looking up any other information system, the result of the particular time period.

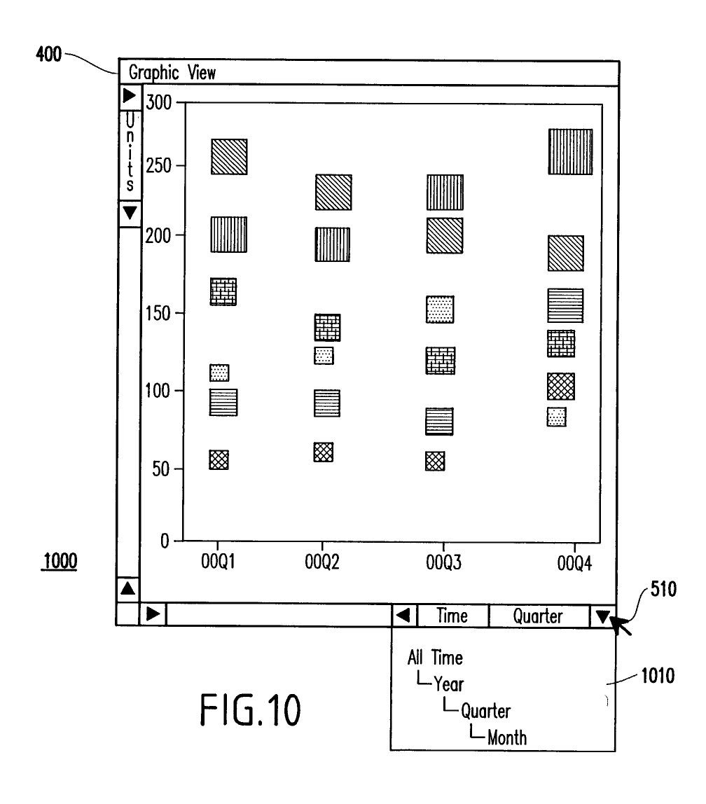

FIG. 10 is a display 1000 of a drill-down and roll-up of the time dimension in the Graphic View 400. A user can easily change the time unit of the Graphic View 400 by using a pull-down menu 1010 that is provided with the time dimension in the x-axis of the view. Thus, the user can obtain a fine granularity with respect to time.

The user can view the pull-down menu 1010 of time units by pointing at and clicking on the time dimension box by using a pointing device 510, and also can select one of the time unit in the menu again by using the pointing device.

Then, the scatter-plot of purchases boxes in the Graphic View 400 is dynamically updated according to the selected time unit. It is noted that more purchase boxes will be displayed in the Graphic View 400 as the user goes with lower level time units, because there will be one purchase box displayed for each purchase case (e.g., a product segment, a department, or a supplier group), for every displayed value of the selected time unit. The user can control this resolution (granularity) of displayed purchase boxes by dynamically selecting an appropriate time unit from the time dimension menu on the interactive display of the Graphic View 400.

Thus, a hierarchical structure of time is provided for selection by the user. The user can select any level directly from the graphic view. Hence, by placing the cursor 510 on year and clicking on it, provides a history of sales for the year (e.g., preferably on a calendar basis).

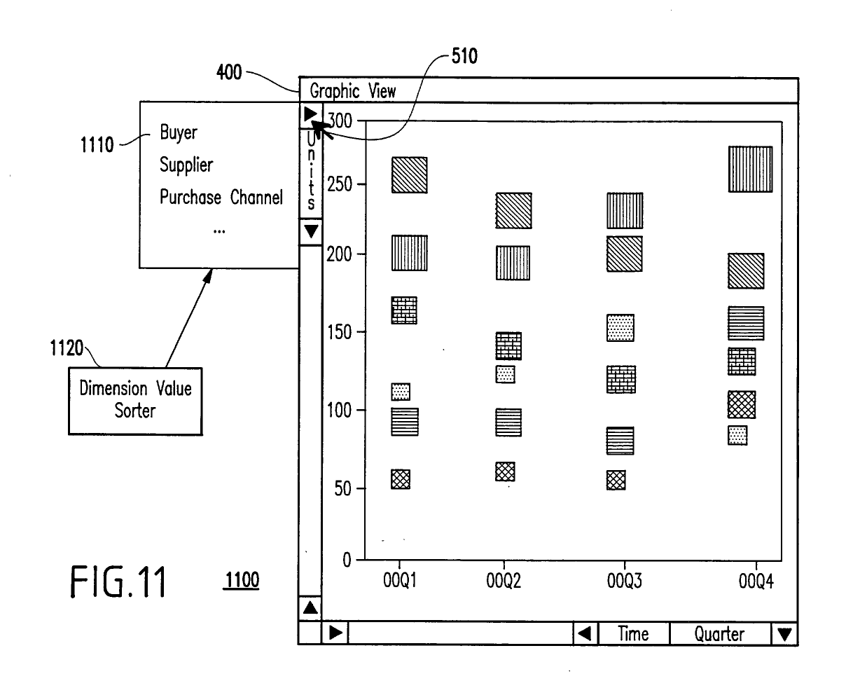

FIG. 11 is a display 1100 showing a selection of a y-axis variable. The default variable for the y-axis of the Graphic View 400 is the number of purchase units, regardless of the unit price.

However, unlike the x-axis that uses the time dimension with change, the user can modify the variable for the y-axis by using a pointing device such as a computer mouse, etc. The procurement analysis system of the present invention provides a pull-down menu along with the y-axis box.

Hence, a user can point to the y-axis box and click on it with a pointing device to view a pull-down menu showing different variables that are available for replacing the current y-axis variable (dimension) of the Graphic View 400.

The user can select one variable from this menu for the y-axis of the Graphic View by using a pointing device. It is noted that the variables shown in this menu for the y-axis are the entire set of dimensions that are shown in the Tree View 300 and the Filter View 310. That is, any dimension from the data cube 270 of the corporate purchase data can be a variable for the y-axis of the Graphic View 400 if users are interested in viewing the purchase case data against the dimension.

It is also noted that the values of the dimension selected for the y-axis of the Graphic View 400 should be presented linearly because the y-axis of the scatter-plot provides only a linear space. Often, the value system of a dimension in corporate purchase data cube is not in linear form. Hence, the system preferably includes a sub-system that can make the values of a selected dimension linear. The linear algorithm may differ from one dimension to another.

For example, a corporation may make the values of buyers (e.g., department names) linear by using an alphabetical order, or assign sequential and unique numbers to departments in the company. The dimension value sorter process 1120 includes linear algorithms that should be used for sequencing the dimension values for the y-axis of the Graphic View 400.

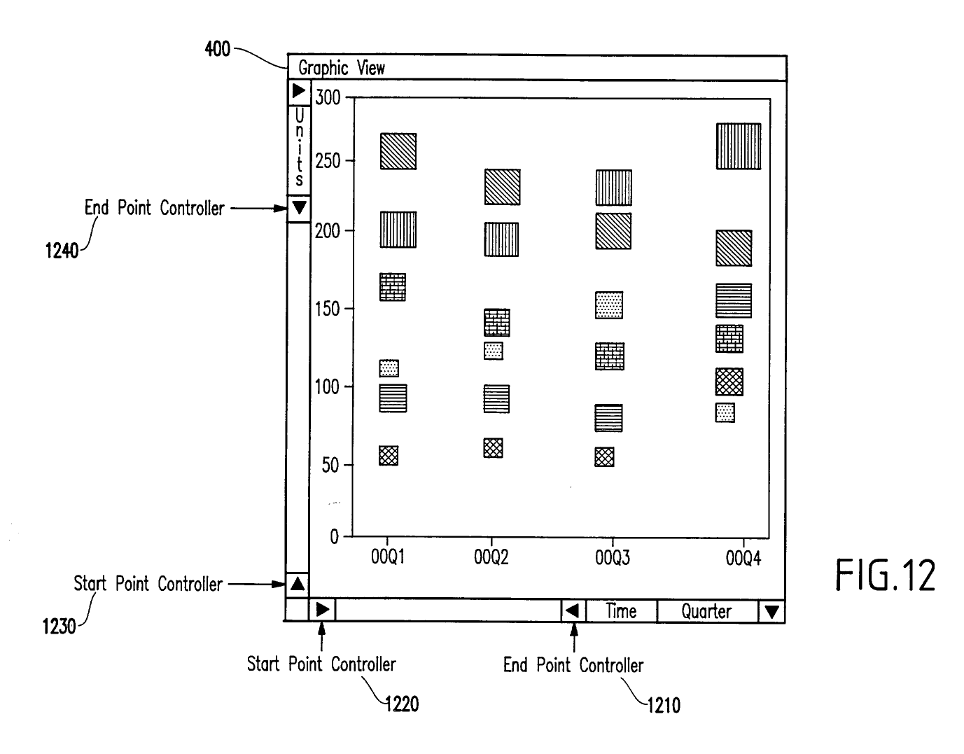

FIG. 12 illustrates an elastic zoning operation by using a scroll bar operation.

Another visual facility provided in the Graphic View 400 is an elastic scroll bar operation that helps zoning the range of data displayed in the view by using a pointing device such as a computer mouse. The user can select a time range of interest by directly changing the lower and upper limit values of the time range using the arrows 1210 and 1220 of the elastic scroll bar for the x-axis of the Graphic View 400.

Similarly, the user can select the range of the y-axis value using the arrows 1230 and 1240 of the elastic scroll bar for the y-axis. As the user changes the value range of either axis, the Graphic View 400 interactively responds to the change and re-displays the purchase boxes in the view only for the updated value scope.

By using this zoning capability, the user can easily and quickly focus on certain areas of the information space (e.g., the first quarter of the year) as needed for analysis and understanding. Thus, the user can dynamically adjust the span/range shown in the graphic view to focus on an area of interest. By using the scroll bar, such zoning can be performed. Such operations can be performed in both the X-and Y-axes.

For example, if only the low volume products were of interest, such as a user being interested only in products having only 150 units or less sold, then the y-axis scroll bar (e.g., end point controller 1240) could be moved to 150 units. Any information above 150 units sold would be filtered out.

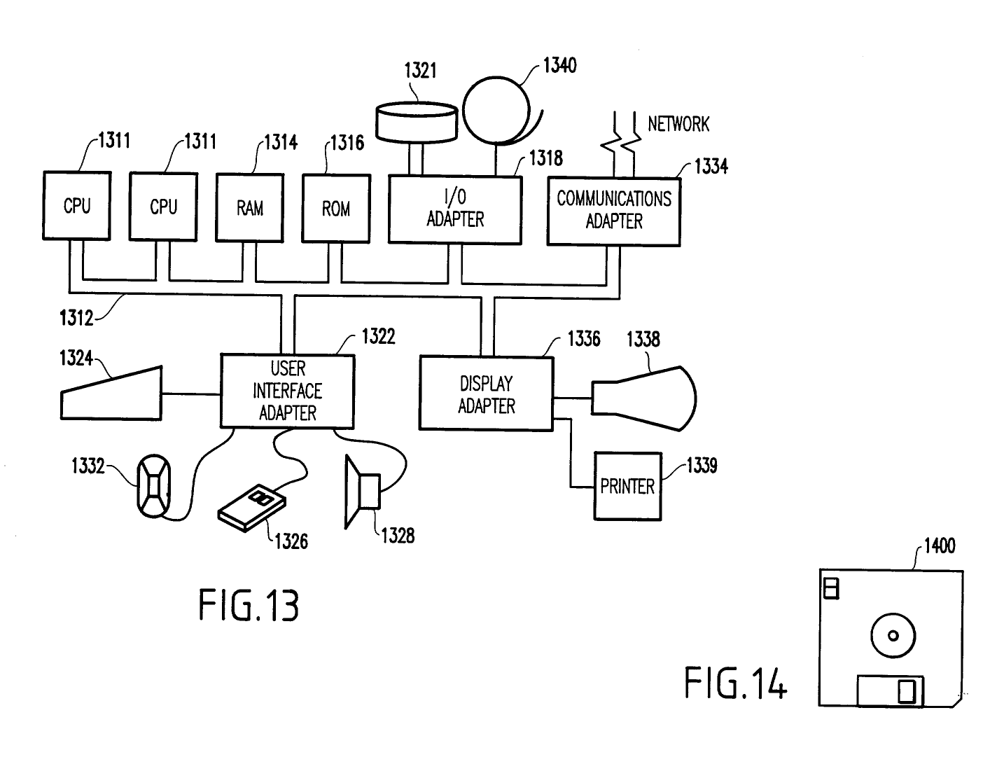

FIG. 13 illustrates a typical hardware configuration of an information handling/computer system for use with the invention and which preferably has at least one processor or central processing unit (CPU) 1311.

The CPUs 1311 are interconnected via a system bus 1312 to a random access memory (RAM) 1314, read-only memory (ROM) 1316, input/output (I/O) adapter 1318 (for connecting peripheral devices such as disk units 1321 and tape drives 1340 to the bus 1312), user interface adapter 1322 (for connecting a keyboard 1324, mouse 1326, speaker 1328, microphone 1332, and/or other user interface device to the bus 1312), a communication adapter 1334 for connecting an information handling system to a data processing network, the Internet, an Intranet, a personal area network (PAN), etc., and a display adapter 1336 for connecting the bus 1312 to a display device 1338 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 1311, as represented by the fast-access storage for example. Alternatively, the instructions may be contained in another signal-bearing media, such as a magnetic data storage diskette 1400 (FIG. 14), directly or indirectly accessible by the CPU 1311.

Whether contained in the diskette 1400, the computer/CPU 1311, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of preferred embodiments, those skilled in the art will recognize that the invention can be practiced with modification within the spirit and scope of the appended claims.

For example, while it is noted that this method and visual user interface has been described above with regard to general applications in the analysis of business procurement data, other applications would find equally great benefit with the present invention, as would be known by one of ordinary skill in the art taking the present application as a whole.

What is claimed is:

1. A method of providing an interactive visual analysis of business expenditure, comprising:
using an interactive graphical view to gain insight into purchase information for assisting in understanding purchase activities and making decisions on purchasing.

2. The method of claim 1, further comprising:
summarizing raw purchasing transaction data and other related information.

3. The method of claim 1, further comprising:
allowing multi-dimensional analysis and views of said purchase information from different perspectives and their combinations.

4. The method of claim 3, wherein said different perspectives include any of time, suppliers, buyers, product types, and purchase channels.

5. The method of claim 1, further comprising:
performing at least one of a drill-down and a roll-up of said purchase information along different perspectives and their combinations.

6. The method of claim 1, further comprising:
filtering said purchase information by dynamically created criteria on different perspectives and their combinations.

7. The method of claim 1, further comprising:
allowing a user to view interactively how corporate purchasing policies are enforced.

8. The method of claim 1, further comprising:
providing insight into spending patterns and trends.

9. The method of claim 1, further comprising:
allowing a user to drill down to a lowest level of detail necessary to determine a cause of leakage and focus organizational resources on its elimination.

10. The method of claim 1, further comprising:
identifying purchases made without benefit of an existing contract.

11. The method of claim 1, further comprising:
allowing a user to view “leakage” over a period of time.

12. The method of claim 1, further comprising:
providing a summarized view of aggregated “leakage” amounts and savings opportunities.

13. The method of claim 1, further comprising:
allowing a user to drill-down details of leakage amount and savings opportunities from different perspectives.

14. The method of claim 1, further comprising:
analyzing a supplier by various attributes.

15. The method of claim 1, further comprising:
interactively identifying most efficient and reliable trading partners.

16. The method of claim 1, further comprising:
allowing a user to view information about purchases in windows dynamically generated from the interactive graphical view by using a pointing device.

17. The method of claim 1, further comprising:
dynamically changing a range of attribute values for which said purchase information is shown in the interactive graphical view by using a pointing device.

18. The method of claim 1, further comprising:
dynamically and interactively analyzing said purchase information on the interactive graphical view and providing decision support to result in an optimum purchasing decision.

19. The method of claim 1, further comprising:
providing the interactive graphical view as a visual user interface including a Tree View, a Filter View, and a Graphic View.

20. The method of claim 19, wherein said tree view provides a hierarchical presentation of summarized expenditure data against one or more dimensions selected by a user,
wherein the filter view provides a presentation of every dimension of expenditure data in consideration that was not selected by the user for the tree view, and
wherein the graphic view provides a visual presentation of the expenditure data shown on the tree view.

21. The method of claim 19, further comprising:
refining a summarized expenditure data shown in the tree view by using one or more filters associated with the expenditure data dimensions provided in the filter view.

22. The method of claim 19, wherein the graphic view presents an entire expenditure data set in a single display screen to allow the user to explore an information space in an effective manner, and allows the user to directly manipulate a data point on the graphic view to discover patterns and trends.

23. The method of claim 1, further comprising:
performing a multi-dimensional analysis of business procurement.

24. The method of claim 1, further comprising:
assembling raw purchase data as source data from a plurality of different sources; and
aggregating the source data to create a target database,
wherein said target database holds the source data in a predetermined format to facilitate creating one or more data cubes for multi-dimensional analysis.

25. The method of claim 24, wherein said target database provides a consistent view of the data, and includes one set of dimension tables for each data schema which have a same set of attributes.

26. The method of claim 1, wherein the interactive graphical view utilizes a target database,
wherein in the target database, a data cube is prepared for the data, and wherein in each data cube, each action represents one dimension.

27. The method of claim 1, further comprising:
creating a design of data cubes and filters, to generate one or more data cubes.

28. The method of claim 27, further comprising:
with the design of said data cubes and said filters, creating by a multi-dimensional data process one or more data cubes; and
using, by a view rendering process, the data cubes to generate the interactive graphical view including a tree view, a filter view, and a graphic view,
wherein with the interactive graphical view, a user views compact and systematic presentation of business expenditure data, directly manipulates various data points, and interactively filters them with dynamically created data queries.

29. The method of claim 28, wherein the tree view comprises a 2-dimensional rendering of a data cube, and each entry in the tree view represents one or more elements cube of a data cube.

30. The method of claim 28, further comprising:
in the filter view, dynamically creating a filter,
wherein each dimension in the filter view includes a pull-down menu with which the user selects one or more attributes in a hierarchical structure of a particular dimension to dynamically create a filter for filtering in data entries to be shown in the tree view and the graphic view.

31. The method of claim 28, further comprising:
at least one of inserting and replacing one or more dimensions from the filter view into the tree view to change a dimension structure in the tree view, and that of the graphic view, such that views in the tree view and the graphic view are automatically coordinated.

32. The method of claim 19, further comprising:
moving a dimension from the tree view to the filter view by using a drag-and-drop pointing device operation,
wherein the dimension moved from the tree view to the filter view is available for filtering operations in the filter view, and the drag-and-drop dimension operations.

33. The method of claim 19, further comprising:
displaying in the graphic view the data entries on a two-dimensional space, one dimension of said two-dimensional space being a time dimension,
wherein the user dynamically selects an appropriate unit of time for measurement data display in the graphic view.

34. A system for providing an interactive visual analysis of business expenditure, comprising:
an interactive graphical view to gain insight into purchase information for assisting in making a decision on purchasing, said interactive graphical view comprising:
a tree view, a filter view, and a graphic view each displaying data dynamically linked together.

35. The system of claim 34, further comprising:
a summarizer unit for summarizing raw purchasing transaction data and other related information.

36. The system of claim 34, wherein said interactive graphical view provides a multi-dimensional analysis and views of said purchase information from different perspectives and their combinations,
wherein said different perspectives include any of time, suppliers, buyers, product types, and purchase channels.

37. The system of claim 34, further comprising:
a menu for performing at least one of a drill-down and a roll-up of said purchase information along different perspectives and their combinations.

38. The system of claim 34, further comprising:
a filer for filtering said purchase information by dynamically created criteria on different perspectives and their combinations.

39. The system of claim 34, wherein said interactive graphical view allows a user to view interactively how corporate purchasing policies are enforced.

40. The system of claim 34, further comprising:
a visual icon on said interactive graphical view for allowing a user to drill down to a lowest level of detail necessary to determine a cause of leakage and focus organizational resources on its elimination.

41. The system of claim 34, further comprising:
means for interactively identifying most efficient and reliable trading partners.

42. The system of claim 34, further comprising:
a pointing device for dynamically creating window allowing a user to view information about purchases in said windows.

43. The system of claim 34, further comprising:
a pointing device for dynamically changing a range of attribute values for which said purchase information is shown in the interactive graphical view.

44. The system of claim 34, further comprising:
means for dynamically and interactively analyzing said purchase information on the interactive graphical view and providing decision support to result in an optimum purchasing decision.

45. The system of claim 34, wherein said tree view provides a hierarchical presentation of the summarized expenditure data against one or more dimensions selected by a user.

46. The system of claim 34, wherein the filter view provides a presentation of every dimension of expenditure data in consideration that was not selected by the user for the tree view, and
wherein the graphic view provides a visual presentation of the expenditure data shown on the tree view.

47. The system of claim 46, further comprising:
a pointing device for refining a summarized expenditure data shown in the tree view by using one or more filters associated with the expenditure data dimensions provided in the filter view.

48. The system of claim 47, wherein the graphic view presents an entire expenditure data set in a single screen to allow the user to explore an information space in an effective manner, and allows the user to directly manipulate the data point on the graphic view to discover patterns and trends.

49. An interactive graphical user interface for providing an interactive visual analysis of business expenditure, comprising:
a display for displaying an interactive graphical view for allowing a user to gain insight into purchase information for assisting in making a decision on purchasing,
said interactive graphical view including a tree view, a filter view, and a graphic view each displaying data dynamically linked together.

50. A signal-bearing medium tangibly embodying a program of machine-readable instructions executable by a digital processing apparatus to perform a method of providing an interactive visual analysis of business expenditure, comprising:
using an interactive graphical view to gain insight into purchase information for assisting in understanding purchase activities and making decisions on purchasing.
